(19) United States
(12) Patent Application Publication
(10) Pub. No.: US 2012/0160886 A1
(43) Pub. Date: Jun. 28, 2012

(54) Market Basket System

(76) Inventors: Paul Henny, (US); Joyce Henny, (US)

(21) Appl. No.: 13/151,547

(22) Filed: Jun. 2, 2011

Related U.S. Application Data
(63) Continuation-in-part of application No. 12/980,046, filed on Dec. 28, 2010.

(51) Int. Cl. B60R 9/00

(52) U.S. Cl. 224/411; 224/401

(57) ABSTRACT

A modular basket system, accompanying hand cart, and method for collecting and transporting grocery items. A series of rectangular baskets placed within a standard shopping cart provide storage and organization for groceries while shopping. Handles on the baskets allow easy transfer in and out of the shopping cart. Optionally, a collapsible hand cart provides a means to secure the baskets and transport them without a standard grocery cart. The hand cart comprises a two-wheeled structure that movably supports load, including a collapsible handle and foldable frame for improved storage. Brackets along the handle and frame provide securement for the baskets, while two rear-facing hooks provide for an additional bin attachment. The baskets may be lined with removable bags or insular liners to protect the baskets or to preserve frozen food during transport between the market and home.

### CROSS REFERENCE TO RELATED APPLICATION

This application is a Continuation in Part of U.S. patent application Ser. No. 12/980,046 filed Dec. 28^{th}, 2010, entitled “Market Basket System.”

### BACKGROUND OF THE INVENTION

1. Field of the Invention

The present invention relates to grocery transport baskets and collapsible hand carts for improved collection and transport of grocery items.

2. Description of the Prior Art

Traditional methods of grocery shopping include use of a store-owned hand basket or shopping cart. Organization and separation of food within these structures is nearly impossible, causing cold items to mix with warm ones, and hazardous cleaning supplies to be placed next to edible food. Items are often placed in a common area until check-out, leading to damaged goods or contaminated food products.

After collecting and paying for the desired groceries, the items are generally placed in non-recyclable plastic bags for transportation home. These bags can be extremely harmful to the environment, as most are made from material not readily disposable in an eco-friendly manner. Additionally, they tend to be composed of very thin material, which does not support load imparted from heavy or multiple-contained items. This necessitates the need to either double-bag or place fewer items in each bag, both of which increases material usage and eventual waste. Optionally-requested paper bags are sometimes used, which are often supported with an exteriorly-wrapped plastic bag. Similarly, these bags do not provide adequate lateral support for groceries in transport, allowing items to escape or spill out. This is especially true while transporting plastic bagged or paper bagged items in a vehicle, where sudden changes in momentum cause items to shift.

Traditional methods of collecting and transporting groceries are both inefficient and potentially harmful. In addition to the environmental concerns of grocery bags, the carts used to transport articles of food within a store can be problematic. First, they are commonly stored outdoors, which can leave them covered in dirt and residue. This poses a public health risk when considering their role of transporting food products. Secondly, they tend to become over used. Wheels are frequently dysfunctional and cause the cart to steer awkwardly, and their upper trays do not always extend properly if damaged. Additionally, the carts must be returned to the store after being used, which represents time wasted in taking the cart to a collection point. Leaving the carts unattended in a parking lot is also a public concern that is commonly found at the grocery store. The present invention eliminates these concerns by providing a grocery transport system that does not require store-owned carts or baskets.

Several solutions to these problems have been suggested in the art. U.S. Pat. No. 4,560,096 to Lucas describes a shopping cart-attachable bag system that is useful for storing and organizing retail items. The bags in this patent are comprised of flexible sheet material with lift handles and optionally attachable support members for the rails of the shopping cart. While these are useful for organizing items within a shopping cart, there are no means for containing or supporting the purchased items while transporting the bags home in a car. The flexible bags provide no lateral support, and can lead to spilled or damaged items.

Patents with similar drawbacks include U.S. Pat. No. 5,533,361 to Halpren, which describes an insulated cooler for keeping groceries cold while shopping. This cooler also comprises flexible walls, along with attachment means for a standard shopping cart. Similar to the aforementioned patent, this bag does not provide adequate support for securely transporting groceries outside of a shopping cart. U.S. Pat. No. 7,270,338 to Edgar describes an insulated compartment for frozen items within a grocery cart, in which an open container is fit snugly inside the forward frame of the cart. The open section of this container does not properly organize and secure items either while shopping or transporting the products in a vehicle.

Several patents exist which describe modular hand carts or dollies that can be used to move heavy loads using a plurality of wheels and an extended handle. The devices described in the art are useful for stackably hauling goods, however most are not convenient or useful for shopping for groceries, specifically those delicate items that may crush if stacked. U.S. Pat. No. 6,131,927 to Krawczyk and U.S. Pat. No. 7,044,484 to Wang describe hand carts with these drawbacks. Grocery basket attachments along the rails of these carts are not described, which would separate items and prevent them from crushing one another.

Still other known devices in the field of shopping cart systems include those with combined shopping baskets and carts. These tend to be bulky devices with minimal collapsibility, which limits a consumer's willingness to use them for everyday shopping. These devices include U.S. Pat. No. 5,203,578 to Davidson and U.S. Pat. No. 7,703,776 to Nugent. These patents use baskets to collect products, and a cart device to transport these items. The carts themselves do not substantially collapse, and are therefore less practical for everyday use.

### SUMMARY OF THE INVENTION

In view of the foregoing disadvantages inherent in the known types of combination hand cart and grocery basket systems now present in the prior art, the present invention provides a new combination hand cart and grocery basket system wherein the same can be utilized for providing convenience for the user when collecting and transporting groceries in the marketplace and on the way home.

It is therefore an object of the present invention to provide a basket suitable for use within a traditional shopping cart for collecting and organizing items, and one that can be outfitted with insular or cloth bag liners.

Another object of the present invention is to provide a collapsible hand cart suitable for attaching grocery baskets to improve mobility and transport of products in the store and on the way home.

Yet another object of the present invention is to provide a method of grocery shopping that includes using a hand cart and basket system that eliminates non-reusable material and provides improved collection and transport qualities.

Other objects, features and advantages of the present invention will become apparent from the following detailed description taken in conjunction with the accompanying drawings.

### BRIEF DESCRIPTIONS OF THE DRAWINGS

FIG. 1 shows a forward view of the present invention, wherein baskets are attached to a collapsible hand cart.

FIG. 2 shows a side view of the present invention, wherein baskets are attached to the front of a collapsible hand cart and a basket is attached to its rear.

FIG. 3 shows an embodiment of the present invention, wherein the baskets are utilized independently of a hand cart for collecting and organizing grocery items within a standard shopping cart.

FIG. 4 shows a side view of the hand cart without attached baskets.

FIG. 5 shows a perspective view of the hand cart in is collapsed state.

FIG. 6 shows a rear perspective view of a basket and its V-shaped latch attachment device.

### DETAILED DESCRIPTION OF THE INVENTION

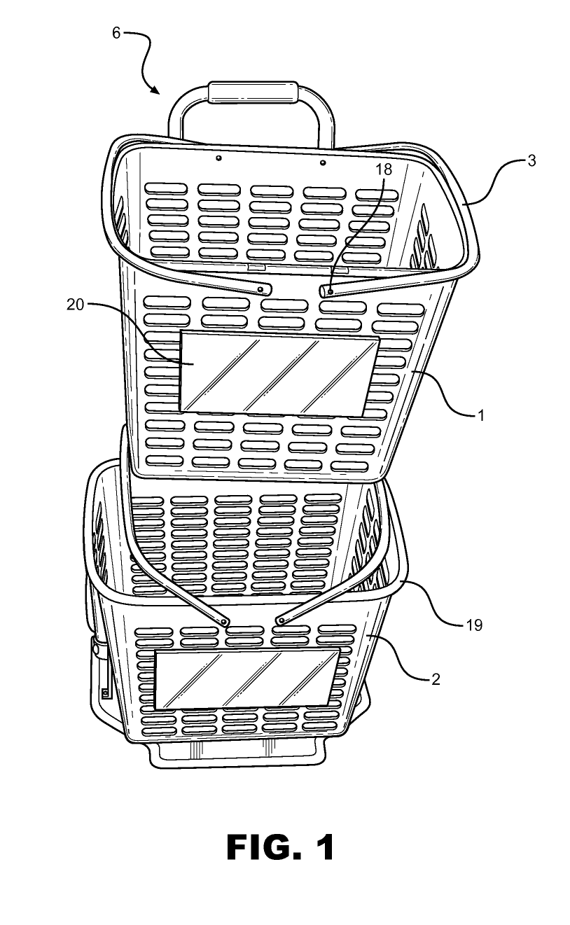

Referring now to FIG. 1, there is shown a frontal view of the first embodiment of the present invention. Two baskets 1 and 2 are removably attached to a hand cart 6. The baskets 1 and 2 are stacked vertically and with a sufficient gap to allow for placement of items in either basket while attached to the hand cart 6. A plurality of handles 3 on each basket 1 and 2 allow the user to easily remove and transport the baskets 1 and 2 in either a filled or empty condition. The handles 3 rotate about their connection to the baskets 18 to form a unified handgrip above each basket 1 and 2 for the user. The baskets 1 and 2 are composed of a lightweight material such as plastic, wicker or other suitable material one in the art would choose, including decorative wire. The baskets 1 and 2 as shown are perforated for ventilation and visibility. Alternatively, the baskets may be comprised of solid sidewall structures. Lips 19 on the upper portion of each basket 1 and 2 allow for another grip point for the user for moving the baskets, and a ledge to tuck an interiorly placed cloth or insular liner 7 around the top rim of each basket 1 and 2. A placard area 20 on each basket provides a consumer or business to place advertisements, logos or other ornamental design desired by the owner. This area provides a flat attachment region for securing adhesive or fastened designs.

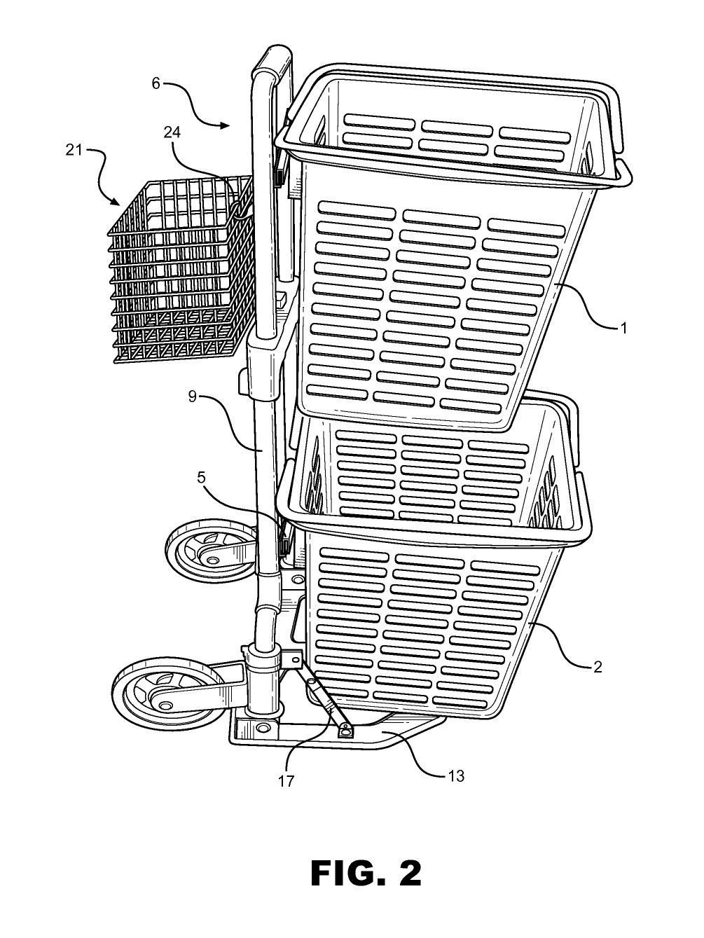

Referring now to FIG. 2, there is shown a side view of the first embodiment of the present invention. Two market baskets 1 and 2 are supported by a hand cart 6. Both baskets 1 and 2 are supported using V-shaped latch devices 5. Each basket includes a latch that mates to a corresponding ledge on the hand cart 6. The latch device supports load from the baskets and distributes it to the structure of the hand cart 6. The V-shape of the latch 5 ensures the baskets will not slide laterally along the while being transported. The lower basket 2 is supported by both the latch device 4 and the base platform 13 of the hand cart, increasing its load carrying capacity. Its location lower on the hand cart also improves stability of the cart and mobility of the heavy load. A removable brace 17 on the outboard edge of the base platform 13 increases the structural stability of the platform while preventing it from collapsing. The additional support from the base platform 13 and the brace 17 provide the lower basket 2 with a larger allowable weight capacity than the upper basket 1, as less stress is placed on the latch device 5. Along the backside of the hand cart 6 is a plurality of accessory hooks 24. These provide attachment points for additional storage, hand bags and other personal items. Shown in FIG. 2 is an additional storage rack 21 that attaches to the hooks 24, providing increased capacity and easy access for the user while transporting goods. Grocery items or personal items may be placed in this additional bin 21, or likewise, the bin 21 may be replaced for attachment of a hand bag.

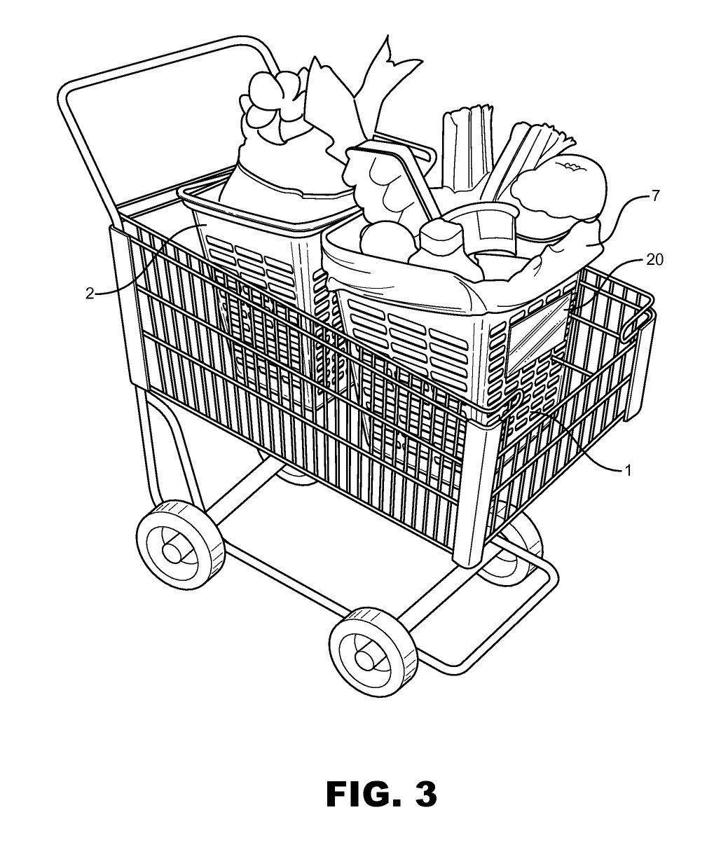

Referring now to FIG. 3, there is shown an alternative embodiment of the present invention, in which the market baskets 1 and 2 are utilized independently from the hand cart 6. The baskets 1 and 2 fit into a standard shopping cart to organize and separate items while shopping. Interior liners 7 may be optionally placed inside the baskets 1 and 2 to keep them clean, allow easy removal of the groceries once back home, as well as add insulation to the baskets 1 and 2 to keep frozen items cold during transport. Each basket may include a placard area 20 for advertisement or personalization.

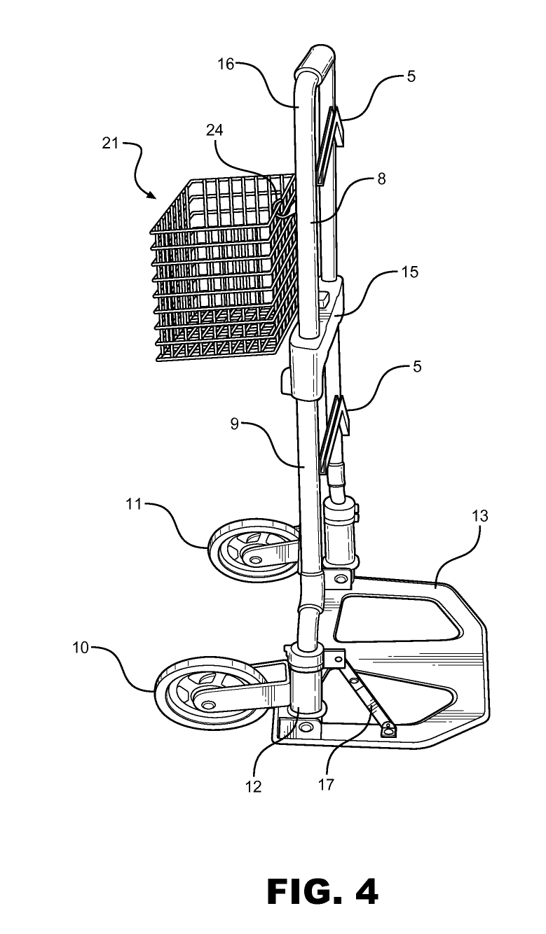

Referring now to FIG. 4, there is shown a side view of the collapsible hand cart 6 in its working configuration. Two parallel lower rails 9 extend vertically and terminate at a junction box 15. Two parallel upper rails 8 extend above the junction box 15, bend toward each other and meet to form a U-shaped handle 16 for the user to handle the cart. Two sets of V-shaped latches 5 are attached to the cart 6, one on the lower rails 9 and one on the upper rails 8 to provide support for an upper and lower basket. These latches mate to the rails and are securely fastened thereto to provide a stable structure for supporting load from the baskets and groceries therein. The upper rails 8 collapse into the lower rails 9 to provide a hand cart in a collapsed state that is easier to handle when transporting or storing. When collapsing, the user pushes down on the handle 16, forcing the upper rails 8 into the lower rails 9. The base platform 13 is also collapsed toward the rails by releasing the support bracket 17 and hingedly rotating the platform 13 inward.

Two wheels 10 and 11 are rotatably mounted to the lower rails 9. The wheel attachment brackets 12 are rotatably mounted to the lower rails 9 to allow the wheels 10 and 11 to rotate inwards for collapsing the hand cart 6. The base platform 13 is shown in its extended position, and is supported by a support brace 17. The base platform 13 can fold towards the lower rails 9 when not in use. Together, the upper rails 8, wheel attachment brackets 12, and the base platform 13 can fold together to permit collapsing of the cart 6.

The two V-shaped latches 5 provide secure placement of both baskets while in use, preventing any sliding or disconnection. The rear of the cart provides connection for additional storage, in the form of additional storage racks 21 or for personal items. Hooks 24 are provided to support the additional load.

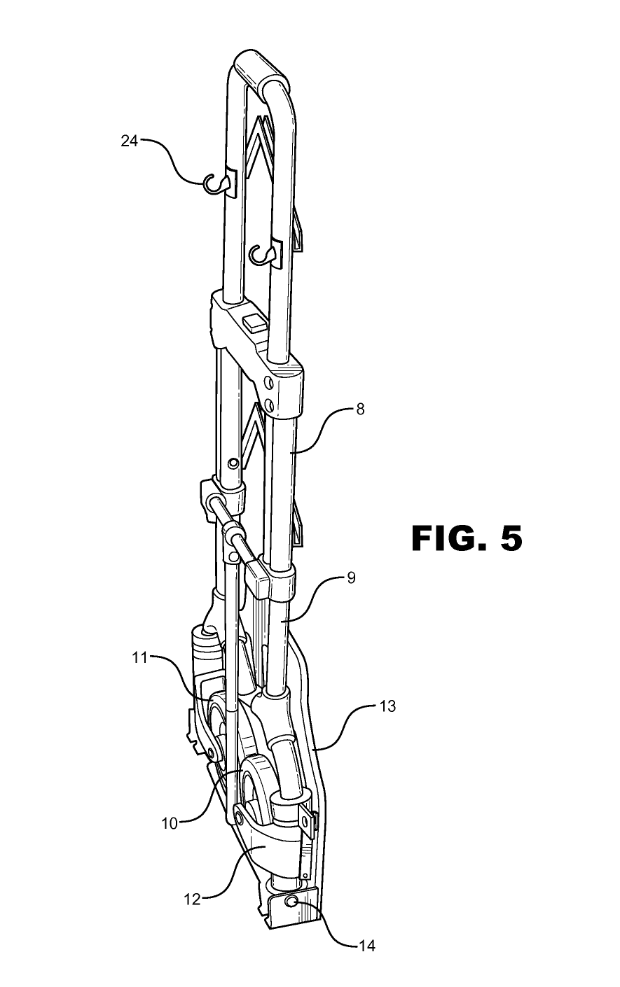

Referring now to FIG. 5, there is shown a perspective view of the hand cart inwards into a collapsed position. As described above, the base platform 13 is folded towards the lower rails 9, the wheels 10 and 11 are folded inward, and the upper rails 8 are condensed into the lower rails 9. This configuration provides a compact configuration for storing and transporting the cart when not in use.

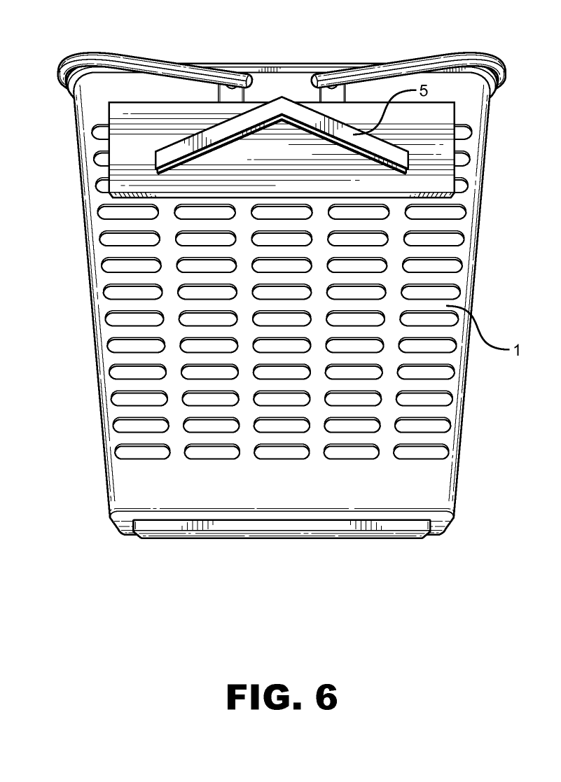

Referring now to FIG. 6, there is shown a rear perspective view of a basket and a view of the V-shaped latch device 5 that is used to attach the basket to a hand cart. The cross section of the latch device 5 is a U-channel that mates with a corresponding U-channel on the hand cart to support load from groceries placed in the basket and to prevent movement of the basket while attached to the hand cart. The V-shape design of the device prevents lateral translation of the basket 1 while attached to the cart, providing a secure means to transport the baskets and load therein.

In use an individual uses the present invention as a method to replace store-owned shopping carts and environmentally harmful grocery bags. The conscious shopper may employ the market baskets in conjunction with the hand cart to grocery shop in a manner that produces no environmentally harmful waste, while also reducing cost for the consumer and the store. Alternatively, the baskets may be used in conjunction with store owned shopping carts for improved organization in the cart and more secure storage in a vehicle. The method and apparatus of the disclosed invention eliminates the cost and waste of the plastic grocery bags, improves grocery organization, and potentially reduces the cost of the shopping carts and the cost of collecting said carts after their use.

As noted, the baskets may be used independently from the hand cart if a store-owned cart is preferred, or if fewer items are required. The basket handles allow the user to carry items with one hand, or they can be placed inside the grocery cart to organize and separate food. After check-out, the baskets are useful for supporting the items in a vehicle and preventing spilled or damaged groceries. Optional cloth or insular liners are capable of being incorporated into the baskets as well.

Use of the baskets in conjunction with a hand cart is particularly useful for those that live in urban areas, wherein transporting goods from the market is a difficult task to complete in one trip. Multiple paper or plastic bags are difficult to carry over long distances, and often necessitate several trips to bring all items home. The hand cart reduces this stress, and improves transportability of multiple items. The baskets can carry heavy loads, while the two-wheeled cart can traverse long distances, uneven terrain, and even steps if necessary. A smaller person can also move larger loads with less personal strain and anxiety.

For those users who drive to the market to purchase items, the baskets provide a convenient means to organize, support and transport items in and out of their vehicle. The number of bags is reduced, and the potential for spills or damaged items is nearly eliminated. The cart is easily collapsible to a form that allows even a small vehicle to house its collapsed structure.

Overall, the present invention provides an environmentally conscious device for gathering and organizing groceries. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A modular basket system for collecting and organizing items, comprising:
one or more baskets with a rectangular opening and a latching means for attaching to a hand cart device, said hand cart device comprising two parallel lower rails connected to upper rails forming a U-shaped handle,
two wheels and a hingeable base platform attached to said lower rails,
a plurality of rearwardly facing accessory hooks attached to said upper rails.

2) A modular basket system as in claim 1, wherein said latching means comprise a V-shaped latch secured to a rear surface of one of said baskets and an inverted V-shaped ledge secured to said hand cart, wherein said inverted V-shaped ledge mates with said V-shaped latch to removably secure said basket to said hand cart.

3) A modular basket system as in claim 1, wherein said base platform is locked into an extended position by a hingeable latch device.

4) A modular basket system as in claim 1, wherein said upper rails are collapsible into said lower rails, said wheels rotate inwards about said lower rails, and said base platform is rotatable into a position parallel to said lower rails to provide a hand cart in a collapsed state.

5) A modular basket system as in claim 1, wherein said accessory hooks attach to a storage rack for increased carrying capacity.

6) A method of shopping, comprising the steps of:
utilizing one or a plurality of baskets to shop for groceries or retail items without using store-provided shopping bags,
utilizing said baskets to organize and separate said groceries within a store-owned shopping cart.

7) A method as recited in claim 6, in which said baskets are lined with fabric bags.

8) A method as recited in claim 7, in which said liners are thermal insulators to keep frozen items cold for long periods of time.

9) A method of shopping, comprising the steps of:
using one or a plurality of rigid baskets to shop for groceries or retail items without using store-provided shopping bags,
utilizing said baskets to organize and separate said groceries using a collapsible hand cart to support and transport said baskets.

10) A method as recited in claim 9, in which said baskets are lined with fabric bags.

11) A method as recited in claim 10, in which said liners are thermal insulators to keep frozen items cold for long periods of time.

12) A modular basket system as in claim 1, further comprising:
a placard secured to a side of a basket.

13) A modular basket system as in claim 1, further comprising an accessory basket secured to said accessory hooks.
